(19) United States
(12) Patent Application Publication
(10) Pub. No.: US 2011/0256014 A1
(43) Pub. Date: Oct. 20, 2011

(54) GRAPHENE/METAL NANOCOMPOSITE POWDER AND METHOD OF MANUFACTURING THE SAME

(76) Inventors: Soon Hyung Hong, Daejeon (KR); Jae Won Hwang, Daejeon (KR); Byung Kyu Lim, Daejeon (KR); Sung Hwan Jin, Daejeon (KR)

(21) Appl. No.: 13/086,749

(22) Filed: Apr. 14, 2011

(30) Foreign Application Priority Data
Apr. 14, 2010 (KR) 10-2010-0034152

(51) Int. Cl. B22F 7/00; B22F 9/18; C01B 31/30; C01B 31/34; B82Y 30/00

(52) U.S. Cl. 419/11; 423/439; 423/440; 75/343; 977/734

(57) ABSTRACT

Graphene/metal nanocomposite powder and a method of preparing the same are provided. The graphene/metal nanocomposite powder includes a base metal and graphenes dispersed in the base metal. The graphenes act as a reinforcing material for the base metal. The graphenes are interposed as thin film types between metal particles of the base metal and bonded to the metal particles. The graphenes contained in the base metal have a volume fraction exceeding 0 vol % and less than 30 vol % corresponding to a limit within which a structural change of the graphenes due to a reaction between the graphenes is prevented.

### TECHNICAL FIELD

The described technology relates generally to nanocomposite powder and a method of manufacturing the same and, more particularly, to graphene/metal nanocomposite powder and a method of manufacturing the same.

### BACKGROUND

A metal is a material having good strength and high thermal and electrical conductivity. Also, since metals are more processable than other materials due to their high ductility, metals may be used in various ways over a wide range of industries.

In recent years, a large amount of research has been conducted on methods of preparing metal nanopowder obtained by applying nano techniques to metals, which are applicable to a wide range of industrial fields. Specifically, in addition to self-characteristics of metals, the mechanical and physical characteristics of metal nanopowder, which were newly discovered with a reduction in the size of metal particles, have attracted much attention. In particular, due to new characteristics caused by a surface effect, a volume effect, and an interaction between particles, metal nanopowder is expected to be applied to advanced materials, such as high-temperature structure materials, tool materials, electromagnetic materials, and materials for filters and sensors. Furthermore, much research has been directed toward maintaining or upgrading the characteristics of conventional metal powder or improving the mechanical characteristics of the conventional metal powder.

### SUMMARY

The present disclosure provides graphene/metal nanocomposite powder containing materials with enhanced mechanical characteristics.

Also, the present disclosure provides a method of manufacturing graphene/metal nanocomposite powder containing materials with enhanced mechanical characteristics.

In one embodiment, graphene/metal nanocomposite powder is provided. The graphene/metal nanocomposite powder includes a base metal and graphenes dispersed in the base metal and acting as a reinforcing material for the base metal. The graphenes are interposed as thin film types between metal particles of the base metal and bonded to the metal particles. The graphenes contained in the base metal have a volume fraction exceeding 0 vol % and less than 30 vol % corresponding to a limit within which a structural change of the graphenes due to a reaction between the graphenes is prevented.

In another embodiment, a graphene/metal nanocomposite material is provided. The metal nanocomposite material contains the above-described graphene/metal nanocomposite powder and is a sintering material prepared using a powder sintering process.

In still another embodiment, a method of manufacturing graphene/metal nanocomposite powder is provided. The method includes dispersing a graphene oxide in a solvent. A salt of a metal as a base metal is provided to the solvent in which the graphene oxide is dispersed. Thereafter, the graphene oxide and the salt of the metal are reduced, thereby preparing the metal nanocomposite powder in which graphenes are dispersed as thin film types between metal particles of the base metal. The dispersed graphenes act as a reinforcing material for the base metal and have a volume fraction exceeding 0 vol % and less than 30 vol % corresponding to a limit within which a structural change of the graphenes due to a reaction between the graphenes is prevented.

In yet another embodiment, a method of preparing a graphene/metal nanocomposite material is provided. The method includes dispersing a graphene oxide in a solvent. A salt of a metal as a base metal is provided in the solvent in which the graphene oxide is dispersed. The salt of the metal contained in the solvent is oxidized to form a metal oxide. The graphene oxide and the metal oxide are reduced, thereby preparing powder in which graphenes are dispersed as thin film types between metal particles of the base metal. The dispersed graphenes act as a reinforcing material for the base metal and are controlled to have a volume fraction exceeding 0 vol % and less than 30 vol % corresponding to a limit within which a structural change of the graphenes due to a reaction between the graphenes is prevented.

In further another embodiment, a method of manufacturing a graphene/metal nanocomposite material is provided. The method includes forming a bulk material by sintering the graphene/metal nanocomposite powder prepared using the method according to one embodiment of the present disclosure at a temperature of approximately 50 to 80% of a melting point of a base metal.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIGS. 1A and 1B are scanning electron microscope (SEM) images of graphene/metal nanocomposite powder according to one embodiment;

FIG. 2 is a SEM image of graphene/metal nanocomposite powder according to one comparative example;

FIGS. 3A and 3B are SEM images of fractures of bulk materials manufactured according to one embodiment and one comparative example, respectively;

FIG. 4 is a flowchart illustrating a method of manufacturing graphene/metal nanocomposite powder according to one embodiment;

FIG. 5 is a flowchart illustrating a method of manufacturing graphene/metal nanocomposite powder according to another embodiment;

FIG. 6 is a transmission electron microscope (TEM) image of graphene/copper (Cu) nanocomposite powder according to one embodiment;

FIG. 7 is an SEM image of graphene/nickel (Ni) nanocomposite powder according to one embodiment;

FIG. 8 is an SEM image of graphene/Cu nanocomposite powder according to one embodiment;

FIG. 9 is a graph showing measurement results of stress-strain characteristics of graphene/Cu nanocomposite powder according to one embodiment; and

FIG. 10 is a graph showing measurement results of stress-strain characteristics of graphene/Cu nanocomposite powder according to one embodiment.

### DETAILED DESCRIPTION

It will be readily understood that the components of the present disclosure, as generally described and illustrated in the Figures herein, could be arranged and designed in a wide variety of different configurations. Thus, the following more detailed description of the embodiments of apparatus and methods in accordance with the present disclosure, as represented in the Figures, is not intended to limit the scope of the disclosure, as claimed, but is merely representative of certain examples of embodiments in accordance with the disclosure. The presently described embodiments will be best understood by reference to the drawings, wherein like parts are designated by like numerals throughout. Moreover, the drawings are not necessarily to scale, and the size and relative sizes of the layers and regions may have been exaggerated for clarity.

It will also be understood that when an element or layer is referred to as being “on,” another element or layer, the element or layer may be directly on the other element or layer or intervening elements or layers may be present.

A term “graphene” used in the present disclosure refers to a single-sheet or multi-sheet material in which a plurality of carbon atoms are covalently bonded to each other to form polycyclic aromatic molecules. The covalently bonded carbon atoms may be, for example, five-membered, six-membered, or seven-membered cyclic basic repeating units.

In the present disclosure, “graphene/metal” composite powder refers to powder containing a metal or an alloy thereof as a base metal, in which graphenes are dispersed in the base metal. The “base metal” inclusively refers to various kinds of metals or alloys functioning as a base of powder. A term “graphene/metal nanocomposite powder” used herein refers to nanoscale composite powder containing a metal or a metal alloy as a base metal, in which graphenes are dispersed in the base metal. In one example, “graphene/copper (Cu) nanocomposite powder” refers to nanoscale composite powder containing Cu or a Cu alloy as a base metal, in which graphenes are dispersed in the base metal. The nanoscale refers to a diameter, length, height, or width of approximately 10 μm or less.

### Graphene/Metal Nanocomposite Powder

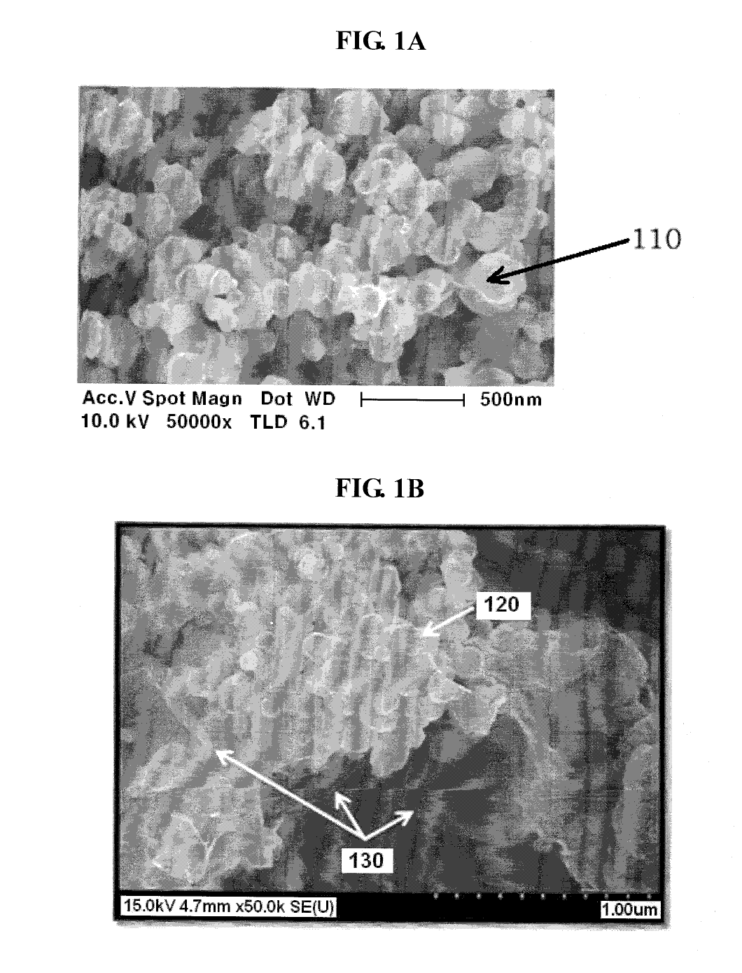

Graphene/metal nanocomposite powder according to one embodiment of the present disclosure may include a base metal and graphenes dispersed in the base metal. The graphenes may be interposed as thin film types between metal particles of the base metal and bonded to the metal particles. The graphene may be a single layer or multilayer of carbon (C) atoms, for example, a film having a thickness of about 100 nm or less. According to one embodiment, the base metal may be a metal or alloy containing at least one selected from the group consisting of copper (Cu), nickel (Ni), cobalt (Co), molybdenum (Mo), iron (Fe), potassium (K), ruthenium (Ru), chromium (Cr), gold (Au), silver (Ag), aluminum (Al), magnesium (Mg), titanium (Ti), tungsten (W), lead (Pb), zirconium (Zr), zinc (Zn), and platinum (Pt), but is not limited thereto. According to another embodiment, one of various kinds of metals forming metal salts in a solvent may be used as the base metal. Hereinafter, one embodiment in which Cu is used as the base metal will be described with reference to FIG. 1.

FIGS. 1A and 1B are scanning electron microscope (SEM) images of graphene/metal nanocomposite powder according to one embodiment. Specifically, FIG. 1A is an SEM image of a Cu base metal in which graphenes are not dispersed, and FIG. 1B is an SEM image of a graphene/Cu base metal in which graphenes are dispersed.

When comparing FIGS. 1A and 1B, graphene/Cu nanocomposite powder according to one embodiment is manufactured by dispersing graphenes 130 in the Cu base metal. FIG. 1A shows arrangement in which Cu particles 110 are regularly bonded in the Cu base metal. In contrast, as shown in FIG. 1B, graphene/Cu nanocomposite powder is structured such that the Cu base metal is mixed with graphenes. The metal particles 120 of Cu contained in the Cu base metal may have a size of several hundreds of nm or less. The graphenes 130 may be interposed as thin film types between the metal particles 120 in the Cu base metal. The graphenes 130 may be dispersed in the Cu base metal and bonded to the metal particles 120 and act as a reinforcing material for improving a mechanical characteristic, such as the tensile strength of the Cu base metal. However, in one example, when the amount of the graphenes 130 dispersed in the Cu base metal exceeds a predetermined threshold value, the inventor has found that a structural change of the graphenes 130 occurs due to condensation or agglomeration between the graphenes 130 caused by a reaction between the graphenes 130. In one example, the structural change of the graphenes 130 may be a structural change of the graphenes 130 into graphite, etc. It has been found that the structural change of the graphenes 130 in a portion of the nanocomposite powder may weaken the function of the graphenes 130 for improving the mechanical characteristic of the Cu base metal. Thus, the amount of the graphenes 130 dispersed in the Cu base metal may be appropriately controlled and have a threshold value of about 30 vol %. Accordingly, the graphenes 130 contained in the nanocomposite powder may be controlled to have a volume fraction exceeding 0 vol % and less than 30 vol %. The graphene/metal nanocomposite powder shown in FIG. 1B according to one embodiment may have a graphene volume fraction of approximately 5 vol %.

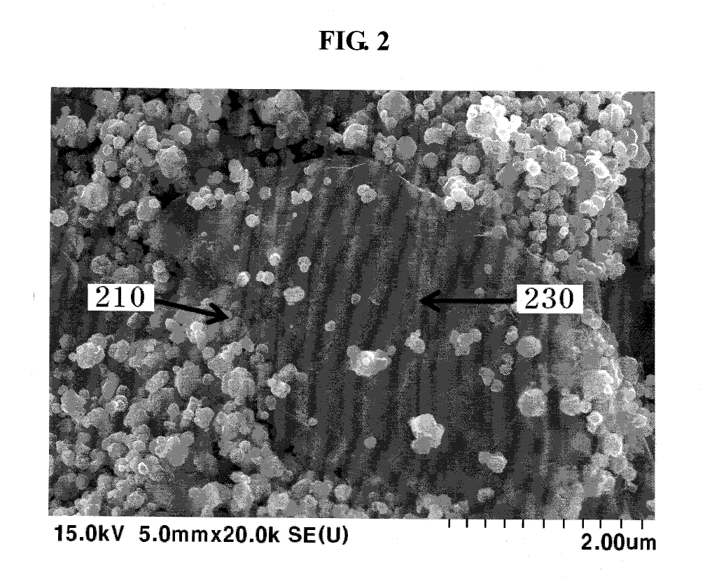

FIG. 2 is a SEM image of graphene/metal nanocomposite powder according to one comparative example. The graphene/metal nanocomposite powder shown in FIG. 2, according to the comparative example, may contain Cu 210 as a base metal and have a graphene volume fraction of approximately 30 vol %. As shown in FIG. 2, in the case of the graphene/Cu nanocomposite powder having a graphene volume fraction of approximately 30 vol %, graphenes 230 may be condensed or agglomerated due to a reaction therebetween in the graphene/Cu nanocomposite powder. When the graphenes 230 are condensed or agglomerated, uniform dispersion of the graphenes 230 may be impeded in the Cu base metal. Accordingly, the function of the graphenes 230 acting as a reinforcing material for improving the mechanical characteristic of the Cu base metal may be degraded.

As described above, in the graphene/metal nanocomposite powder according to one embodiment of the present disclosure, graphenes dispersed in a base metal may be controlled to have a volume fraction exceeding 0 vol % and less than 30 vol %. The graphenes may be bonded with metal particles of the base metal and serve as a reinforcing material for improving the mechanical characteristic of the base metal. According to other embodiments, the graphenes serving as a conductive material may be bonded with the metal particles of the base metal to improve the electrical characteristics (e.g., electrical conductivity) of the base metal. The graphenes are known to have a high mobility of about 20,000 to 50,000 cm²/Vs. Thus, the nanocomposite powder manufactured by bonding the graphenes with the metal particles of the base metal according to the present disclosure may be applied to high-value-added component materials as is, such as highly conductive, highly elastic wire coating materials or wear-resistant coating materials.

According to other embodiments, the graphene/metal nanocomposite powder according to the present disclosure may be converted into a bulk material using a powder sintering process. That is, the graphene/metal nanocomposite powder may be sintered to form the bulk material. According to one embodiment, the sintering process may be carried out under a high pressure at a temperature of approximately 50 to 80% of a melting point of the base metal. A nanocomposite material corresponding to the bulk material may be applied to electromagnetic component materials, such as connector materials or electronic packaging materials, or metal composite materials, such as materials for high-strength highly elastic structures. The bulk material according to one embodiment of the present disclosure may be manufactured using the graphene/metal nanocomposite powder having a graphene volume fraction exceeding 0 vol % and less than 30 vol %.

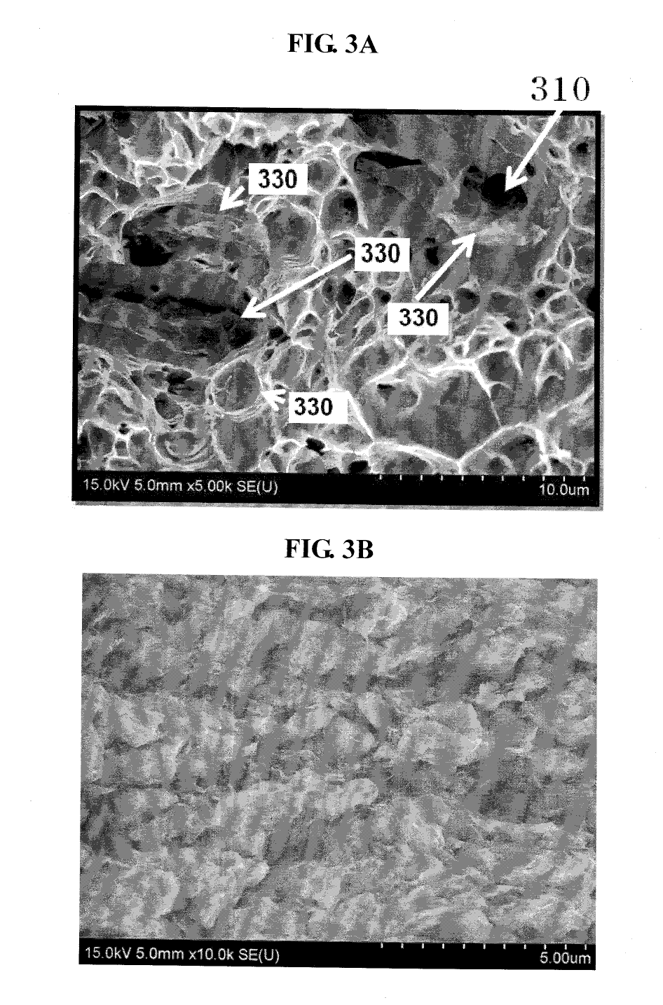

FIGS. 3A and 3B are SEM images of fractures of bulk materials manufactured according to one embodiment and one comparative example, respectively. FIG. 3A shows a bulk material manufactured by sintering graphene/Cu nanocomposite powder containing graphenes with a volume fraction of approximately 1 vol %, and FIG. 3B shows a bulk material manufactured by sintering graphene/Cu nanocomposite powder containing graphenes with a volume fraction of approximately 30 vol %. Both the sintering processes of FIGS. 3A and 3B were performed in the temperature range of from 50 to 80% of a melting point of a Cu base metal under the same conditions.

Referring to FIG. 3A, it can be seen that the bulk material contains a conic dimple 310 observed after sintering powder of a ductile metal, such as Cu. Also, it can be observed that graphenes 330 are substantially uniformly distributed in the bulk material. Referring to FIG. 3B, no dimple 310 is observed from the fracture of the bulk material. That is, it can be inferred that powder of Cu as a ductile metal was comparatively insufficiently sintered. Accordingly, it can be concluded that the sintering of the graphene/Cu nanocomposite powder may be inhibited due to a graphene content of 30 vol %.

### Method of Manufacturing Graphene/Metal Nanocomposite Powder

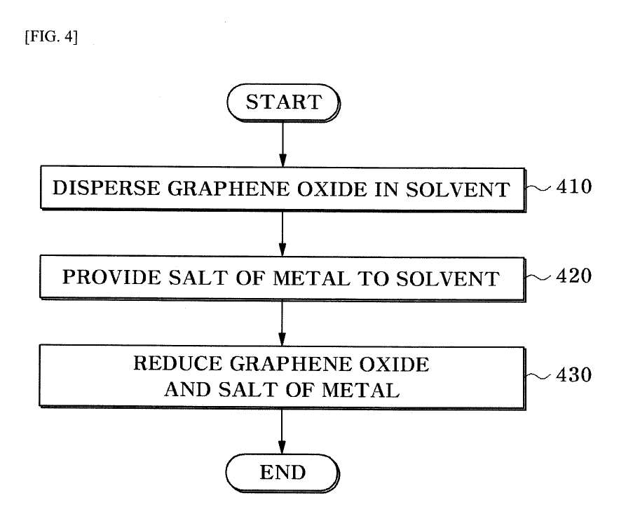

FIG. 4 is a flow chart illustrating a method of manufacturing graphene/metal nanocomposite powder according to one embodiment. Referring to FIG. 4, in operation 410, a graphene oxide may be provided and dispersed in a solvent. The graphene oxide may be separated from a graphite structure using a known method such as, for example, Hummers process or a modified Hummers process. For example, the Hummers process is disclosed in Journal of the American Chemical Society 1958, 80, 1339 by Hummers et al, and a technique disclosed in this paper may constitute a portion of a technique according to the present disclosure.

The solvent may contain, for example, ethylene glycol, but is not limited thereto. A variety of kinds of known solvents in which the graphene oxide may be substantially uniformly dispersed may be used. The graphene oxide may be a single sheet oxidized and separated from a carbon multilayered structure of the graphite by the known method such as the Hummers or the modified Hummers process. The graphene oxide may be substantially uniformly distributed using a dispersion process, such as an ultrasonic treatment process.

In operation 420, a salt of a metal may be provided in the solvent. For example, the metal may be, but is not limited to, a metal or alloy containing at least one selected from the group consisting of Cu, Ni, Co, Mo, Fe, K, Ru, Cr, Au, Ag, Al, Mg, Ti, W, Pb, Zr, Zn, and Pt and may contain various kinds of metals forming metal salts in the solvent. In this case, the amount of the salt of the metal as compared with the amount of the graphene oxide dispersed in the solvent may be controlled. That is, to prevent condensation or agglomeration of graphenes to which the graphene oxide is reduced during a subsequent process, the amounts of the graphene oxide and the salt of the metal may be controlled. According to one embodiment, the amounts of the graphene oxide and the salt of the metal may be controlled such that the graphene dispersed in graphene/metal nanocomposite powder as a final product has a volume fraction exceeding 0 vol % and less than 30 vol %. According to the inventor, when the graphene oxide and the salt of the metal are provided such that the graphenes have a volume fraction of more than 30 vol %, it has been found that the structural change of the graphenes may occur due to the condensation or agglomeration between the graphenes. The structural change of the graphenes may be, for example, transformation of the graphenes into graphite, etc. That is, the transformed graphenes in the graphene/metal nanocomposite powder may impede the function of the graphenes for improving the mechanical properties of the base metal. In one example, the graphene oxide and the salt of the metal may be substantially uniformly mixed in the solvent using an ultrasonic treatment process or a magnetic mixing process.

In operation 430, the graphene oxide and the salt of the metal may be reduced. According to one embodiment, a reducing agent may be provided to the solvent containing the graphene oxide and the salt of the metal, and a reducing process may be performed using a thermal treatment. The reducing agent such as hydrazine (H₂NH₂) may be used. According to one embodiment, the reducing process may include thermally treating a solution containing the graphene oxide, the salt of the metal, and the reducing agent at a temperature of approximately 70 to 100° C. in a reduction atmosphere. Due to the reducing process, the graphene/metal nanocomposite powder containing the metal as a base metal and the graphenes interposed as thin film types between metal particles of the base metal may be obtained.

Furthermore, the obtained graphene/metal nanocomposite powder may be washed using ethanol or water to remove impurities. For example, the graphene/metal nanocomposite powder may be dried by performing a thermal treatment using an oven at a temperature of approximately 80 to 100° C. According to some embodiments, the obtained graphene/metal nanocomposite powder may be thermally treated under a reduction atmosphere containing hydrogen (H₂). As a result, impurities (e.g., oxygen (O)) remaining in the graphene/metal nanocomposite powder may be removed, thereby improving the crystallinity of the graphene. For example, the hydrogen-induced thermal treatment may be performed by means of a tube-type furnace using a hydrogen-containing gas as a reactive gas. For instance, the hydrogen-induced thermal treatment may be performed at a temperature of approximately 300 to 700° C. for about 1 to 4 hours.

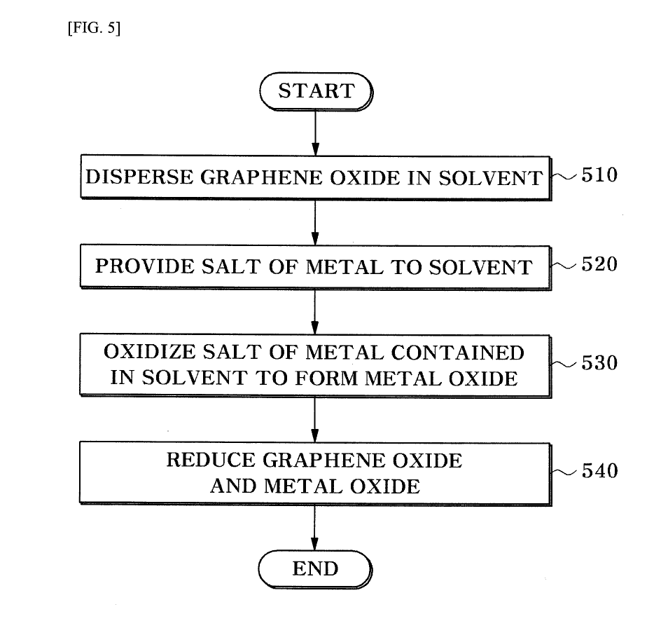

FIG. 5 is a flowchart illustrating a method of preparing graphene/metal nanocomposite powder according to another embodiment. Referring to FIG. 5, in operation 510, a graphene oxide may be provided and dispersed in a solvent. The graphene oxide may be separated from a graphite structure using a known method such as Hummers process or a modified Hummers process. For example, the Hummers process is disclosed in Journal of the American Chemical Society 1958, 80, 1339 by Hummers et al, and a technique disclosed in this paper may constitute a portion of a technique according to the present disclosure.

The solvent may be, for example, distilled water or alcohol, but is not limited thereto. A variety of kinds of known solvents in which the graphene oxide may be substantially uniformly dispersed may be used. The graphene oxide may be a single sheet oxidized and separated from a carbon multilayered structure of the graphenes by the known method such as the Hummers process or the modified Hummers process. The graphene oxide may be substantially uniformly distributed using a dispersion process, such as an ultrasonic treatment process.

In operation 520, a salt of a metal may be provided in the solvent. For example, the metal may be, but is not limited to, a metal or alloy containing at least one selected from the group consisting of Cu, Ni, Co, Mo, Fe, K, Ru, Cr, Au, Ag, Al, Mg, Ti, W, Pb, Zr, Zn, and Pt, and contain various kinds of metals forming metal salts in the solvent. In this case, the amount of the salt of the metal as contrasted with the amount of the graphene oxide dispersed in the solvent may be controlled. That is, to prevent agglomeration of graphenes to which the graphene oxide is reduced during a subsequent process, the amounts of the graphene oxide and the salt of the metal may be controlled. According to one embodiment, the amounts of the graphene oxide and the salt of the metal may be controlled such that the graphenes dispersed in graphene/metal nanocomposite powder as a final product have a volume fraction exceeding 0 vol % and less than 30 vol %. According to the inventor, when the graphene oxide and the salt of the metal are provided such that the graphenes have a volume fraction of more than 30 vol %, it has been found that the structural change of the graphenes may occur due to the condensation or agglomeration between the graphenes. The structural change of the graphenes may be, for example, transformation of the graphenes into graphite, etc. That is, the transformed graphenes in the graphene/metal nanocomposite powder may impede the function of the graphenes for improving the mechanical properties of the base metal. In one example, the graphene oxide and the salt of the metal may be substantially uniformly mixed in the solvent using, for example, an ultrasonic treatment process or a magnetic mixing process.

In operation 530, the salt of the metal contained in the solvent may be oxidized to produce a metal oxide. According to one embodiment, an oxidizing agent may be provided to the solvent containing the graphene oxide and the salt of the metal, and an oxidation process may be performed using a thermal treatment to produce an oxide of the metal. The oxidizing agent may be, for example, sodium hydroxide (NaOH). According to one embodiment, the oxidation process may include thermally treating a solution containing the graphene oxide, the salt of the metal, and the oxidizing agent at a temperature of approximately 40 to 100° C. Due to the oxidation process, the metal oxide may be produced from the salt of the metal. As a result, the graphene oxide may be bonded to the metal oxide to form composite powder. The bond between the graphene oxide and the metal oxide may inclusively refer to a physical or chemical bond between the graphene oxide and the metal oxide.

Afterwards, the composite powder containing the graphene oxide and the metal oxide may be separated from the solvent. In one embodiment, the separation of the composite powder from the solvent may be performed using a centrifugal separator. The composite powder from which the solvent is removed may be washed using water and ethanol. The composite powder may be filtered under a vacuum using a filter with a fine porosity and a pump. Thus, purer composite powder containing the graphene oxide and the metal oxide may be obtained.

In operation 540, the graphene oxide and the metal oxide may be reduced. According to one embodiment, the composite powder containing the graphene oxide and the metal oxide may be thermally treated in a reduction atmosphere. In one example, the composite powder may be reduced at a temperature of approximately 200 to 800° C. in a reducing furnace having a hydrogen atmosphere for 1 to 6 hours. As a result, due to the reducing process, the graphene/metal nanocomposite powder containing the metal as a base metal and the graphenes interposed as thin film types between metal particles of the base metal may be obtained.

By the processes of the above-described embodiments, graphene/metal nanocomposite powder in which graphenes are dispersed in a base metal and bonded to metal particles of the base metal may be manufactured. According to some embodiments, the prepared nanocomposite powder may be sintered to form a bulk material. According to one embodiment, the sintering process may be carried out under a high pressure at a temperature of approximately 50 to 80% of a melting point of the base metal. In one example, graphene/Cu nanocomposite powder may be sintered under a pressure of approximately 50 MPa at a temperature of approximately 500 to 900° C.

By the process of the above-described embodiment, graphene/metal nanocomposite powder may be manufactured. The graphenes contained in the graphene/metal nanocomposite powder may be bonded to the metal particles of the base metal and act as a reinforcing material for improving the mechanical characteristics of the base metal. According to other embodiments, the graphenes functioning as a conductive material may be bonded to the base metal to improve the electrical characteristics of the graphene/metal nanocomposite powder. The graphenes are known to have a high mobility of about 20,000 to 50,000 cm²/Vs. Thus, graphene/metal nanocomposite powder manufactured by bonding the graphenes with the metal particles of the base metal according to the present disclosure may be applied to high-value-added component materials as is, such as highly conductive, highly elastic wire coating materials or wear-resistant coating materials.

According to some embodiments, a nanocomposite material corresponding to the bulk material formed using the above-described sintering process may be applied to electromagnetic component materials, such as connector materials or electronic packaging materials, or metal composite materials, such as materials for high-strength highly elastic structures.

Hereinafter, graphene/metal nanocomposite powder manufactured using a method according to any one of the embodiments of the present disclosure will be described in detail with respect to specific examples and experimental examples; however, these examples are merely illustrative to make the present disclosure better understood and do not limit the scope of the present disclosure.

### EXAMPLE 1

Cu and Ni were applied as base metals of graphene/metal nanocomposite powder according to one embodiment of the present disclosure. To begin with, graphene oxide powder was produced from graphite using the Hummers process. After adding the graphene oxide to an ethylene glycol solvent, the graphene oxide was uniformly dispersed in the ethylene glycol solvent using an ultrasonic treatment process. As a result, a graphene oxide dispersion solution was prepared.

A copper hydrate and a nickel hydrate were respectively added as metal salts in the prepared graphene oxide dispersion solution. Hydrazine was added as a reducing agent to a solution containing a mixture of the graphene oxide and the copper hydrate, and the solution was thermally treated to prepare graphene/Cu nanocomposite powder in which graphenes were dispersed in a Cu base metal. Also, hydrazine was added as a reducing agent to a solution containing a mixture of the graphene oxide and the nickel hydrate, and the solution was thermally treated to prepare graphene/Ni nanocomposite powder in which graphenes were dispersed in a Ni base metal. The prepared graphene/Cu nanocomposite powder and graphene/Ni nanocomposite powder were washed using ethanol and water and dried in an oven. The graphene/Cu nanocomposite powder was manufactured to have a graphene volume fraction of approximately 5 vol %, and the graphene/Ni nanocomposite powder was manufactured to have a graphene volume fraction of approximately 1 vol %.

To evaluate the mechanical characteristics of graphene/metal nanocomposite powder according to one embodiment of the present disclosure, additional graphene/Cu nanocomposite powder was prepared. 12 mg of the graphene oxide was mixed with 16 g of Cu(II) acetate monohydrate as the copper hydrate using an ethylene glycol solvent. Graphene/Cu nanocomposite powder was manufactured using the above-described method of the present disclosure, and graphenes contained in the graphene/Cu nanocomposite powder had a volume fraction of 0.69 vol %, which represented a weight fraction of 0.17 wt %.

### EXAMPLE 2

Cu was applied as a base metal of graphene/metal nanocomposite powder according to one embodiment of the present disclosure. To begin with, graphene oxide powder was produced from graphite using the Hummers process. After the graphene oxide was added to distilled water, the graphene oxide was uniformly dispersed in the distilled water using an ultrasonic treatment process. As a result, a graphene oxide dispersion solution was prepared.

Cu(II) acetate monohydrate as a copper hydrate was mixed with the prepared graphene oxide dispersion solution. Sodium hydroxide (NaOH) was provided as an oxidizing agent, and a mixture was thermally treated at a temperature of approximately 80° C. to prepare composite powder containing the graphene oxide and the copper oxide. The composite powder was separated from the distilled water using a centrifugal separator and filtered under a vacuum. The composite powder was reduced using a thermal treatment in a hydrogen reducing furnace to manufacture graphene/Cu nanocomposite powder in which graphenes were dispersed in a Cu base metal. The graphene/Cu nanocomposite powder was manufactured to have a graphene volume fraction of 5 vol %.

### EXPERIMENTAL EXAMPLE

SEM images of graphene/Cu nanocomposite powder with a graphene volume fraction of 5 vol % and graphene/Ni nanocomposite powder with a graphene volume fraction of 1 vol % obtained in Example 1 were captured. A transmission electron microscope (TEM) image of the graphene/Cu nanocomposite powder with the graphene volume fraction of 5 vol % was additionally captured. Stress/strain characteristics of each of graphene/Cu nanocomposite powder with a graphene volume fraction of approximately 0.69% according to Example 1 and pure Cu powder were measured to make a comparison between the graphene/Cu nanocomposite powder with a graphene volume fraction of approximately 0.69% according to Example 1 and the pure Cu powder in terms of mechanical characteristics and estimate the comparison results.

A SEM image of graphene/Cu nanocomposite powder with a graphene volume fraction of 5 vol % obtained in Example 2 was captured. Stress/strain characteristics of each of graphene/Cu nanocomposite powder with a graphene volume fraction of approximately 5 vol % according to Example 2 and pure Cu powder were measured to make a comparison between the graphene/Cu nanocomposite powder with a graphene volume fraction of approximately 5 vol % according to Example 1 and the pure Cu powder in terms of mechanical characteristics and estimate the comparison results.

### Evaluation

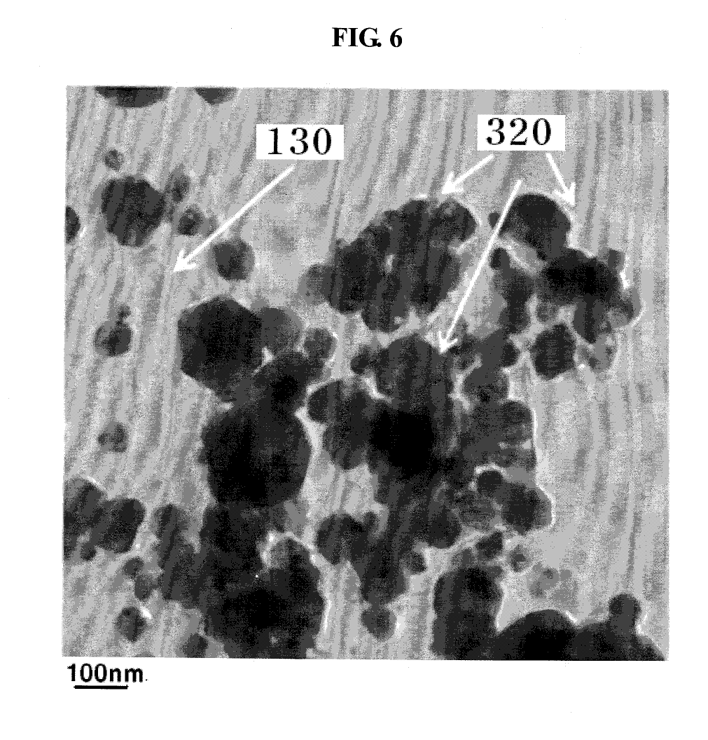

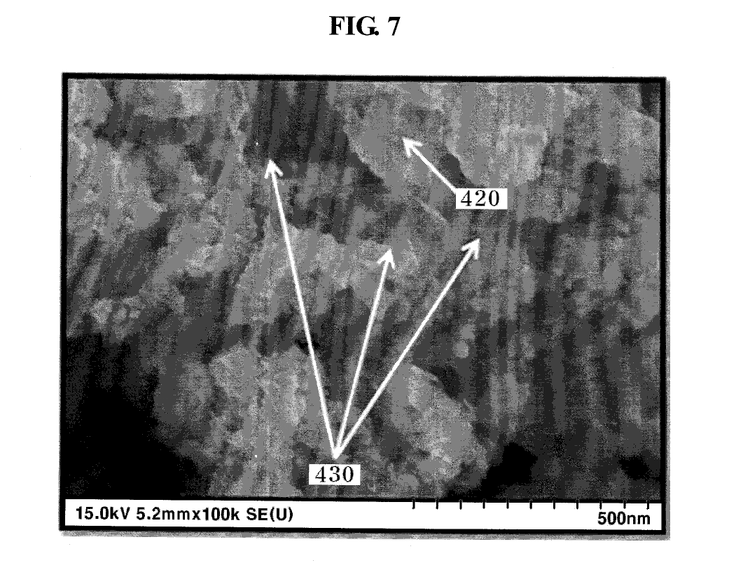

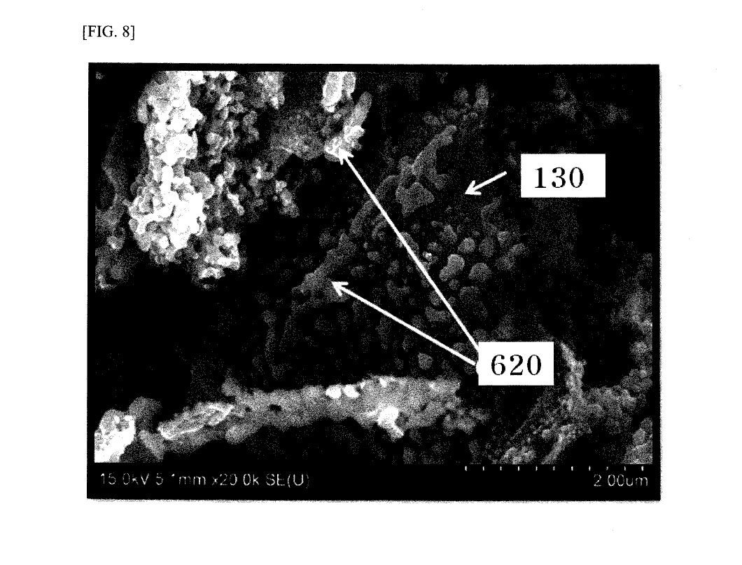

FIG. 6 is a TEM image of graphene/Cu nanocomposite powder according to one embodiment. Specifically, FIG. 6 is a TEM image of graphene/Cu nanocomposite powder with a graphene volume fraction of 5 vol % prepared using the method according to Example 1. FIG. 7 is a SEM image of graphene/Ni nanocomposite powder according to one embodiment. Specifically, FIG. 7 is a SEM image of graphene/Ni nanocomposite powder with a graphene volume fraction of 1 vol % prepared using the method according to Example 1. FIG. 8 is a SEM image of graphene/Cu nanocomposite powder according to one embodiment. Specifically, FIG. 8 is a SEM image of graphene/Cu nanocomposite powder with a graphene volume fraction of 5 vol % prepared using the method according to Example 2.

Referring to the SEM images of FIGS. 1B and 8 and the TEM image of FIG. 6, metal particles 120, 620, and 820 contained in the Cu base metal had a size of several hundred nm or less. It can be observed that graphenes 130 with a volume fraction of 5 vol % in the Cu nanocomposite powder were interposed as thin film types between the metal particles 120, 620, and 820 of the Cu base metal. Referring to FIG. 7, it can be observed that graphenes 730 with a volume fraction of 1 vol % were interposed as thin film types between metal particles 720 of the Ni base metal.

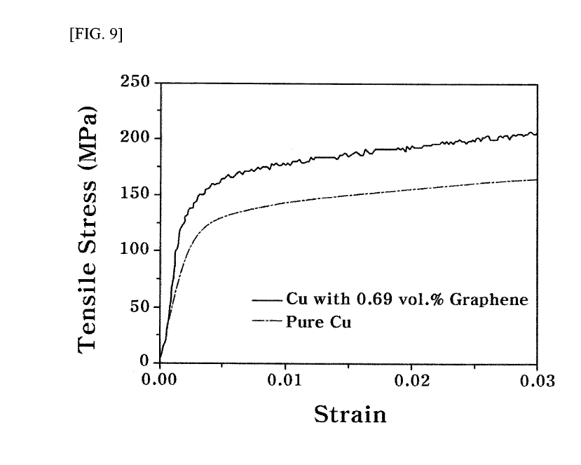

FIG. 9 is a graph showing measurement results of stress-strain characteristics of graphene/Cu nanocomposite powder according to one embodiment, which were obtained using the graphene/Cu nanocomposite powder with a graphene volume fraction of 0.69 vol % according to Example 1 and pure Cu powder. Referring to FIG. 9, it can be observed that the graphene/Cu nanocomposite powder had a higher tensile stress than the pure Cu powder in both an elastic region and a plastic region. For example, the graphene/Cu nanocomposite powder had an approximately 30% higher tensile stress than the pure Cu powder in a strain section of approximately 0.01 or more. Accordingly, it can be inferred that the graphenes were dispersed in the Cu base metal and bonded to Cu particles of the Cu base metal and functioned as a reinforcing material to increase the mechanical strength of the nanocomposite powder.

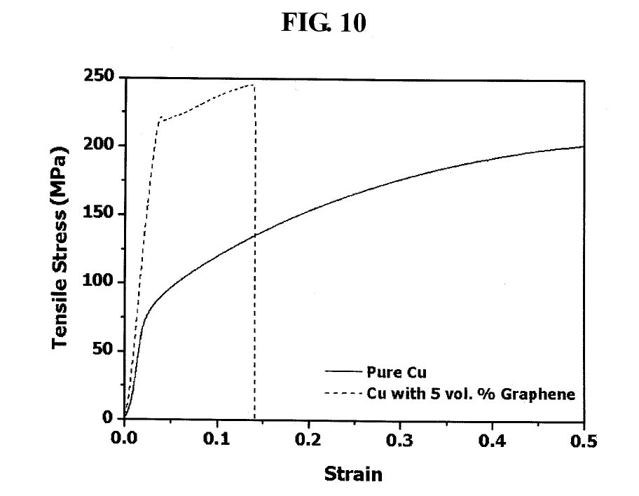

FIG. 10 is a graph showing measurement results of stress-strain characteristics of graphene/Cu nanocomposite powder according to one embodiment, which were obtained using the Cu nanocomposite powder with a graphene volume fraction of 5 vol % according to Example 2 and pure Cu powder. Referring to FIG. 10, the graphene/Cu nanocomposite powder had a yield strength of approximately 221 MPa, while the pure Cu powder had a yield strength of approximately 77.1 MPa. Also, the graphene/Cu nanocomposite powder had an elastic modulus of 72.5 GPa, while the pure Cu powder had an elastic modulus of 46.1 GPa. Accordingly, the graphene/Cu nanocomposite powder exhibited better mechanical characteristics than the pure Cu powder in the elastic region.

In the plastic region, the graphene/Cu nanocomposite powder had a tensile strength of approximately 245 MPa, while the pure Cu powder had a tensile strength of approximately 202 MPa, so it can be seen that the graphene/Cu nanocomposite powder exhibited a better tensile strength than the pure Cu powder. However, the graphene/Cu nanocomposite powder had an elongation of approximately 43%, while the pure Cu powder had an elongation of approximately 12%, so it can be seen that the pure Cu powder had a better elongation than the Cu nanocomposite powder.

According to the embodiments of the present disclosure, graphenes are interposed as thin film types between metal particles of a base metal and bonded to the metal particles, thereby improving mechanical or electrical characteristics of the base metal.

According to the embodiments of the present disclosure, graphene/metal nanocomposite powder with enhanced mechanical or electrical characteristics can be easily prepared.

The foregoing is illustrative of the present disclosure and is not to be construed as limiting thereof. Although numerous embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. Graphene/metal nanocomposite powder comprising:
a base metal; and
graphenes dispersed in the base metal and acting as a reinforcing material for the base metal,
wherein the graphenes are interposed as thin film types between metal particles of the base metal and bonded to the metal particles, and
the graphenes contained in the base metal have a volume fraction exceeding 0 vol % and less than 30 vol % corresponding to a limit within which a structural change of the graphenes due to a reaction between the graphenes is prevented.

2. The graphene/metal nanocomposite powder according to claim 1, wherein the metal particles have a size of 1 nm to 10 μm.

3. The graphene/metal nanocomposite powder according to claim 1, wherein the base metal comprises at least one selected from the group consisting of copper (Cu), nickel (Ni), cobalt (Co), molybdenum (Mo), iron (Fe), potassium (K), ruthenium (Ru), chromium (Cr), gold (Au), silver (Ag), aluminum (Al), magnesium (Mg), titanium (Ti), tungsten (W), lead (Pb), zirconium (Zr), zinc (Zn), and platinum (Pt).

4. A graphene/metal nanocomposite material serving as a powdered sintering material comprising the graphene/metal nanocomposite powder according to claim 1.

5. A method of manufacturing graphene/metal nanocomposite powder, comprising:
(a) dispersing a graphene oxide in a solvent;
(b) providing a salt of a metal as a base metal to the solvent in which the graphene oxide is dispersed; and
(c) forming powder in which graphenes are dispersed as thin film types between metal particles of the base metal by reducing the graphene oxide and the salt of the metal,
wherein the dispersed graphenes act as a reinforcing material for the base metal and are controlled to have a volume fraction exceeding 0 vol % and less than 30 vol % corresponding to a limit within which a structural change of the graphenes due to a reaction between the graphenes is prevented.

6. The method according to claim 5, wherein the salt of the metal is a salt hydrate comprising at least one selected from the group consisting of Cu, Ni, Co, Mo, Fe, K, Ru, Cr, Au, Ag, Al, Mg, Ti, W, Pb, Zr, Zn, and Pt.

7. The method according to claim 5, further comprising (d) thermally treating the formed powder using hydrogen (H₂) at a temperature of 300 to 700° C.

8. The method according to claim 5, wherein operation (c) comprises reducing the graphene oxide and the salt of the metal using a reducing agent at a temperature of 70 to 100° C.

9. A method of manufacturing a metal nanocomposite material comprising forming a bulk material by sintering the graphene/metal nanocomposite powder manufactured according to claim 5 under a high pressure at a temperature of 50 to 80% of a melting point of a base metal.

10. A method of manufacturing metal nanocomposite powder, comprising:
(a) dispersing a graphene oxide in a solvent;
(b) providing a salt of a metal as a base metal to the solvent in which the graphene oxide is dispersed;
(c) forming a metal oxide by oxidizing the salt of the metal contained in the solvent; and
(d) forming powder in which graphenes are dispersed as thin film types between metal particles of the base metal by reducing the graphene oxide and the metal oxide,
wherein the dispersed graphenes act as a reinforcing material for the base metal and are controlled to have a volume fraction exceeding 0 vol % and less than 30 vol % corresponding to a limit within which a structural change of the graphenes due to a reaction between the graphenes is prevented.

11. The method according to claim 10, wherein the salt of the metal is a salt hydrate comprising at least one selected from the group consisting of Cu, Ni, Co, Mo, Fe, K, Ru, Cr, Au, Ag, Al, Mg, Ti, W, Pb, Zr, Zn, and Pt.

12. The method according to claim 10, wherein operation (d) comprises thermally treating the nanocomposite powder containing the graphene oxide and the metal oxide in a reduction atmosphere.

13. The method of claim 10, wherein operation (c) comprises providing an oxidizing agent to the solvent comprising the graphene oxide and the salt of the metal and performing a thermal treatment.

14. A method of manufacturing a graphene/metal nanocomposite material, comprising forming a bulk material by sintering the graphene/metal nanocomposite powder prepared using the method of claim 10 at a temperature of 50% to 80% of a melting point of the base metal.
